(19) United States
(12) Patent Application Publication
(10) Pub. No.: US 2026/0077654 A1
(43) Pub. Date: Mar. 19, 2026

(54) Management Device, Energy Storage Apparatus, System, and Communication Method

(71) Applicant: GS Yuasa International Ltd., Kyoto-shi, Kyoto (JP)

(72) Inventors: Masahiro TATSUMI, Kyoto-shi, Kyoto (JP); Masashi NAKAMURA, Kyoto-shi, Kyoto (JP)

(21) Appl. No.: 19/106,972

(22) PCT Filed: Sep. 8, 2023
(86) PCT No.: PCT/JP2023/032821

§ 371 Date: Feb. 26, 2025

(30) Foreign Application Priority Data
Sep. 14, 2022 (JP) 2022-146153

(51) Int. Cl. B60L 3/00; B60L 58/12; G06F 8/65

(52) U.S. Cl. CPC B60L 3/0084; B60L 58/12; G06F 8/65; B60L 2240/549

(57) ABSTRACT

A battery management unit that manages an energy storage cell, the battery management unit including: a current sensor that measures a charge/discharge current in the energy storage cell; a first communication unit that communicates with a vehicle; and a management unit, in which the management unit executes: determination processing of detecting, by the current sensor, a pulse pattern occurring in the charge/discharge current in the energy storage cell, and determining whether or not the detected pulse pattern matches a predetermined pattern; and communication processing of communicating with the vehicle via the first communication unit when it is determined in the affirmative in the determination processing.

### CROSS REFERENCE TO RELATED APPLICATIONS

This application is a National Stage Application, filed under 35 U.S.C. § 371, of International Application No. PCT/JP2023/032821, filed Sep. 8, 2023, which international application claims priority to and the benefit of Japanese Application No. 2022-146153, filed Sep. 14, 2022; the contents of both of which are hereby incorporated by reference in their entirety.

### BACKGROUND

### Technical Field

The technology disclosed in the present specification relates to a management device, an energy storage apparatus, a system, and a communication method for managing an energy storage cell.

### Description of Related Art

Conventionally, an energy storage apparatus provided with a communication unit that communicates with an apparatus is known (for example, refer to Japanese App. Pub. No. 2022-18218 (“JP 2022-18218 A”)). Specifically, the energy storage apparatus described in JP 2022-18218 A is mounted on a vehicle (corresponding to the apparatus), and includes: a battery cell that supplies electric power to an electric load mounted on the vehicle; and a management device that manages the battery cell. The management device includes a communication unit, and communicates with a vehicle ECU (electronic control unit) via the communication unit.

In recent years, a function of connecting to a telecommunication line such as the Internet or a mobile phone network has started to be provided for a vehicle. A vehicle provided with such a function is referred to as a “connected car”, or the like. In such a vehicle, a control program (so-called firmware) of the vehicle ECU can also be updated remotely via a telecommunication line.

### BRIEF SUMMARY

When an energy storage apparatus is mounted on a vehicle having a function of connecting to a telecommunication line, a management device included in the energy storage apparatus is also connected to outside of the vehicle via the vehicle, and therefore, there is a concern about cyberattack on the management device.

An object of an aspect of the present invention is to improve robustness against cyberattacks on a management device that manages an energy storage cell.

Provided is a management device that manages an energy storage cell, the management device including: a current sensor that measures a charge/discharge current in the energy storage cell; a first communication unit that communicates with at least one apparatus from among an apparatus to which electric power is supplied from the energy storage cell, an apparatus that charges the energy storage cell, and an apparatus that exchanges signals with the management device; and a management unit, in which the management unit executes: determination processing of detecting, by the current sensor, a pulse pattern occurring in the charge/discharge current in the energy storage cell, and determining whether or not the detected pulse pattern matches a predetermined pattern; and communication processing of communicating with the apparatus via the first communication unit when it is determined in the affirmative in the determination processing.

According to the above-described configuration, robustness against cyberattacks on a management device that manages the energy storage cell improves. That is, by generating and utilizing a predetermined pattern that cannot be easily reproduced or generated, a more robust system can be constructed.

### BRIEF DESCRIPTION OF THE FIGURES

FIG. 1 is a schematic diagram illustrating an outer appearance of a system according to a first embodiment.

FIG. 2 is a schematic diagram of the system.

FIG. 3 is a block diagram illustrating a configuration of an on-board ECU.

FIG. 4 is an exploded perspective view of an energy storage apparatus.

FIG. 5A is a plan view of an energy storage cell.

FIG. 5B is a cross-sectional view taken along line A-A illustrated in FIG. 5A.

FIG. 6 is a block diagram illustrating an electrical configuration of the energy storage apparatus.

FIG. 7 is a flowchart of communication processing with an on-board ECU.

FIG. 8 is a flowchart of communication processing with an on-board ECU for the second time or later according to a third embodiment.

### DETAILED DESCRIPTION OF VARIOUS EMBODIMENTS

### Outline of Embodiments

(1) A management device according to an embodiment is a management device that manages an energy storage cell, the management device including: a current sensor that measures a charge/discharge current in the energy storage cell; a first communication unit that communicates with at least one apparatus from among an apparatus to which electric power is supplied from the energy storage cell, an apparatus that charges the energy storage cell, and an apparatus that exchanges signals with the management device; and a management unit, in which the management unit executes: determination processing of detecting, by the current sensor, a pulse pattern occurring in the charge/discharge current in the energy storage cell, and determining whether or not the detected pulse pattern matches a predetermined pattern; and communication processing of communicating with the apparatus via the first communication unit when it is determined in the affirmative in the determination processing.

In the communication between the management device and the apparatus according to the above (1), the predetermined pattern is determined in advance between the apparatus and the management device. When the apparatus communicates with the management device, the apparatus generates a pulse pattern corresponding to the predetermined pattern in a discharge current supplied from the energy storage cell to the apparatus or a charge current by which the apparatus charges the energy storage cell. The management device determines whether or not a pulse pattern occurring in a charge current or a discharge current (hereinafter referred to as “charge/discharge current”) matches a predetermined pattern. By doing so, the management device can determine whether or not the communication counterpart is the legitimate communication counterpart with which the management device determined a predetermined pattern in advance.

Since cyberattacks on the management device mainly infiltrate through the first communication unit, robustness against cyberattacks on the management device improves by determining, from the pulse pattern, whether or not the communication counterpart is the legitimate communication counterpart, and rejecting communication via the first communication unit when the communication counterpart is not the legitimate communication counterpart. That is, by generating and utilizing a predetermined pattern that cannot be easily reproduced or generated, a more robust system can be constructed.

(2) In the management device according to the above (1), the management unit may perform encrypted communication with the apparatus via the first communication unit.

According to the management device described in the above (2), by using both the pulse pattern to be generated in the charge/discharge current, and encryption of communication, the robustness of security is further improved.

(3) In the management device according to the above (1) or (2), a configuration is possible in which, in the case of receiving update firmware of the management unit from the apparatus via the first communication unit, the management unit executes the determination processing before receiving the update firmware, and when it is determined in the affirmative in the determination processing, the management unit receives the update firmware from the apparatus via the first communication unit in the communication processing.

For example, when an apparatus to which electric power is supplied from the energy storage cell or an apparatus that charges the energy storage cell has a function of connecting to a telecommunication line, it is possible to remotely update firmware of the management unit included in the management device via the telecommunication line. In that case, if the firmware is updated to falsified firmware, the management device may fall into a state not originally intended.

According to the management device described in the above (3), the determination processing is executed before the update firmware is received, and the update firmware is received when it is determined in the affirmative in the determination processing. In other words, the management device receives the update firmware after confirming that an apparatus that is the transmission source of the update firmware is the legitimate communication counterpart with which the management device determined a predetermined pattern in advance. By doing so, it is possible to reduce the possibility that the firmware of the management unit included in the management device will be updated by falsified firmware.

(4) In the management device according to any one of the above (1) to (3), a configuration is possible in which, in the case of accepting, via the first communication unit, diagnosis by an external diagnostic apparatus that diagnoses presence or absence of an abnormality in the management device, the management unit executes the determination processing before accepting the diagnosis by the external diagnostic apparatus, and when it is determined in the affirmative in the determination processing, the management unit accepts the diagnosis by the external diagnostic apparatus via the first communication unit in the communication processing.

Conventionally, an external diagnostic apparatus diagnoses the presence or absence of an abnormality in the management device via an apparatus to which electric power is supplied from the energy storage cell or an apparatus that charges the energy storage cell. In this case, a malicious third party may fraudulently acquire information from the management device by using a device masquerading as an external diagnostic apparatus.

According to the management device described in the above (4), the determination processing is executed before the diagnosis by the external diagnostic apparatus is accepted via the first communication unit, and the diagnosis by the external diagnostic apparatus is accepted when it is determined in the affirmative in the determination processing. By doing so, it is possible to reduce the possibility that the information of the management unit included in the management device is fraudulently acquired.

(5) In the management device according to any one of the above (1) to (4), a configuration is possible in which the management unit executes the determination processing upon first communication with the apparatus, and when it is determined in the affirmative in the determination processing, the management unit communicates with the apparatus via the first communication unit without executing the determination processing upon second and subsequent communications with the apparatus.

If the apparatus being the communication counterpart is confirmed to be the legitimate communication counterpart once, it may not be necessary to detect the pulse pattern every time communication is performed.

According to the management device described in the above (5), the determination processing is executed when communication is performed with the apparatus for the first time, and when it is determined in the affirmative in the determination processing, the determination processing is not executed upon second and subsequent communications, and therefore, the time required for the second and subsequent communications can be shortened.

(6) An energy storage apparatus according to an embodiment is an energy storage apparatus including: an energy storage cell; and the management device according to any one of the above (1) to (5) managing the energy storage cell.

According to the energy storage apparatus described in the above (6), by determining whether or not the communication counterpart is the legitimate communication counterpart from a pulse pattern occurring in the charge/discharge current of the energy storage cell, robustness against cyberattacks on a management device that manages the energy storage cell improves.

(7) A system according to an embodiment is a system including: the energy storage apparatus according to the above (6); and at least one apparatus, being from among an apparatus to which electric power is supplied from the energy storage apparatus, an apparatus that charges the energy storage apparatus, and an apparatus that exchanges signals with the management device; and including a second communication unit that communicates with the management device, in which the apparatus includes a pulse generator that generates a pulse pattern in accordance with the predetermined pattern, in the charge/discharge current in the energy storage apparatus.

According to the system described in the above (7), by determining whether or not the communication counterpart is the legitimate communication counterpart from the pulse pattern occurring in the charge/discharge current of the energy storage cell, robustness against cyberattacks on the management device that manages the energy storage cell improves.

(8) A communication method according to an embodiment is a communication method for use in a management device that manages an energy storage cell, the communication method including: determination of detecting, by a current sensor, a pulse pattern occurring in a charge/discharge current in the energy storage cell, and determining whether or not the detected pulse pattern matches a predetermined pattern; and communication of communicating with an apparatus via a first communication unit when it is determined in the affirmative in the determination.

According to the communication method described in the above (8), by determining whether or not the communication counterpart is the legitimate communication counterpart from the pulse pattern occurring in the charge/discharge current of the energy storage cell, robustness against cyberattacks on the management device that manages the energy storage cell improves.

(9) A communication method according to an embodiment is a communication method for use in communication between an apparatus and a management device that manages an energy storage cell, the communication method including: generation in which the apparatus generates a pulse pattern in accordance with a predetermined pattern, in a charge/discharge current in the energy storage cell; determination in which the management device detects, by a current sensor, the pulse pattern occurring in the charge/discharge current in the energy storage cell, and determines whether or not the detected pulse pattern matches the predetermined pattern; and communication in which the apparatus and the management device communicate with each other when it is determined in the affirmative in the determination.

According to the communication method described in the above (9), by determining whether or not the communication counterpart is the legitimate communication counterpart from the pulse pattern occurring in the charge/discharge current of the energy storage cell, robustness against cyberattacks on the management device that manages the energy storage cell improves.

(10) A communication method according to an embodiment is a communication method for use in a management device that manages an energy storage cell, the communication method including: determination of detecting, by a current sensor, a pulse pattern occurring in a charge/discharge current in the energy storage cell, and determining whether or not the detected pulse pattern matches a predetermined pattern; communication of communicating with an apparatus via a first communication unit when it is determined in the affirmative in the determination; and generation of generating the predetermined pattern.

When the predetermined pattern is fixed to a single predetermined pattern, there is a concern that the predetermined pattern is inferred. According to the communication method described in the above (10), the predetermined pattern can be changed by generating the predetermined pattern.

Accordingly, robustness against cyberattacks on the management device that manages the energy storage cell is further improved as compared to a case where the predetermined pattern is fixed to a single predetermined pattern.

### Details of Embodiments

Embodiments of the present disclosure is described below. The present disclosure is not limited to these examples illustrated, but is defined by the scope of the claims and is intended to include all modifications within the meaning and scope equivalent to the scope of the claims.

The embodiments of the present disclosure may be realized in various aspects, e.g., an apparatus, a method, a computer program for realizing the functions of the apparatus or the method, and a recording medium in which the computer program is recorded.

### First Embodiment

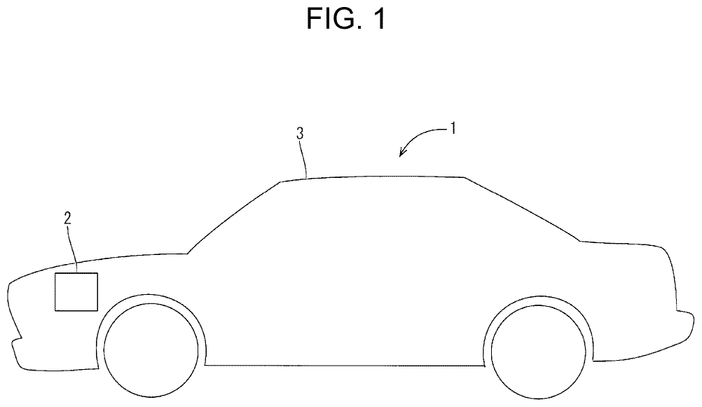

A first embodiment is described below based on FIGS. 1 to 7. In the following description, there may be places where assignment of reference numerals in the drawings is omitted for the same constituting elements, except for a part thereof.

### (1) System Configuration

A system 1 according to the first embodiment is described below with reference to FIG. 1. The system 1 includes a vehicle 3, and an energy storage apparatus 2 mounted on the vehicle 3. The vehicle 3 is an engine automobile using an engine as a drive source. The vehicle 3 is an example of an apparatus to which electric power is supplied from the energy storage apparatus 2 and an apparatus that charges the energy storage apparatus 2. The vehicle 3 may be an electric vehicle (EV), a hybrid vehicle (HV), a plug-in hybrid vehicle (PHV), or the like.

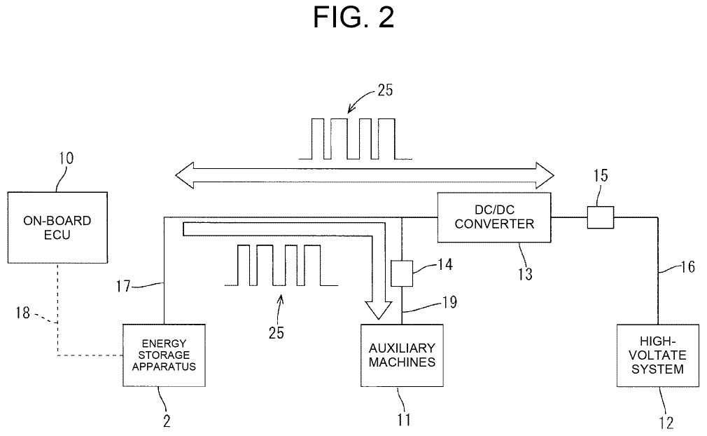

As illustrated in FIG. 2, the vehicle 3 includes an on-board ECU (electronic control unit) 10, auxiliary machines 11, a high-voltage system 12, a DC/DC converter 13, a first FET 14 (field effect transistor), and a second FET 15.

The on-board ECU 10 is an apparatus that controls each unit of the vehicle 3. A configuration of the on-board ECU 10 is described below later.

The auxiliary machines 11 are devices operated by electric power supplied by the energy storage apparatus 2, and specifically, are a headlight, power steering, an electric brake system, an air conditioner, and the like.

The high-voltage system 12 is an engine starting device (a so-called starter motor) which starts an engine of the vehicle 3, a vehicular power generator (a so-called alternator) which generates electric power by using the engine of the vehicle 3 as a power source, or the like. The high-voltage system 12 is connected to the DC/DC converter 13 via an electric line 16.

The DC/DC converter 13 is a bidirectional converter. The DC/DC converter 13 is connected to the energy storage apparatus 2 via an electric line 17. The DC/DC converter 13 converts a voltage supplied from the energy storage apparatus 2 into a predetermined voltage, and supplies the predetermined voltage to the engine starting device. The DC/DC converter 13 converts electric power generated by the vehicular power generator into a predetermined voltage, thereby charging the energy storage apparatus 2.

The first FET 14 is included in an electric line 19 to be described later. The second FET 15 is included in the electric line 16. The first FET 14 and the second FET 15 are for generating the pulse pattern 25 in the charge/discharge current of the energy storage apparatus 2, and are turned on/off by an on-board ECU 10. The on-board ECU 10, the first FET 14, and the second FET 15 are examples of a pulse generator.

The energy storage apparatus 2 is communicably connected to an on-board ECU 10 via a signal line 18. The energy storage apparatus 2 is connected to the DC/DC converter 13 via an electric line 17, and is connected to the auxiliary machines 11 via an electric line 19 branched from the electric line 17.

### (2) Electrical Configuration of On-Board ECU

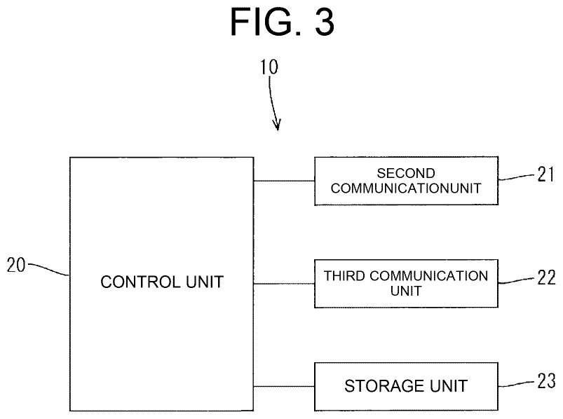

An electrical configuration of the on-board ECU 10 is described below with reference to FIG. 3. The on-board ECU 10 includes a control unit 20, a second communication unit 21, a third communication unit 22, and a storage unit 23.

The control unit 20 includes a CPU, a RAM, and the like. The second communication unit 21 is a communication circuit for the control unit 20 to communicate with various types of equipment (including the energy storage apparatus 2) mounted on the vehicle 3. The third communication unit 22 is a communication circuit for the control unit 20 to communicate with a device outside the vehicle 3 via a telecommunication line such as the Internet or a mobile phone network. The storage unit 23 stores therein various control programs to be executed by the control unit 20, a predetermined pattern determined in advance with the energy storage apparatus 2, and the like.

### (3) Configuration of Energy Storage Apparatus

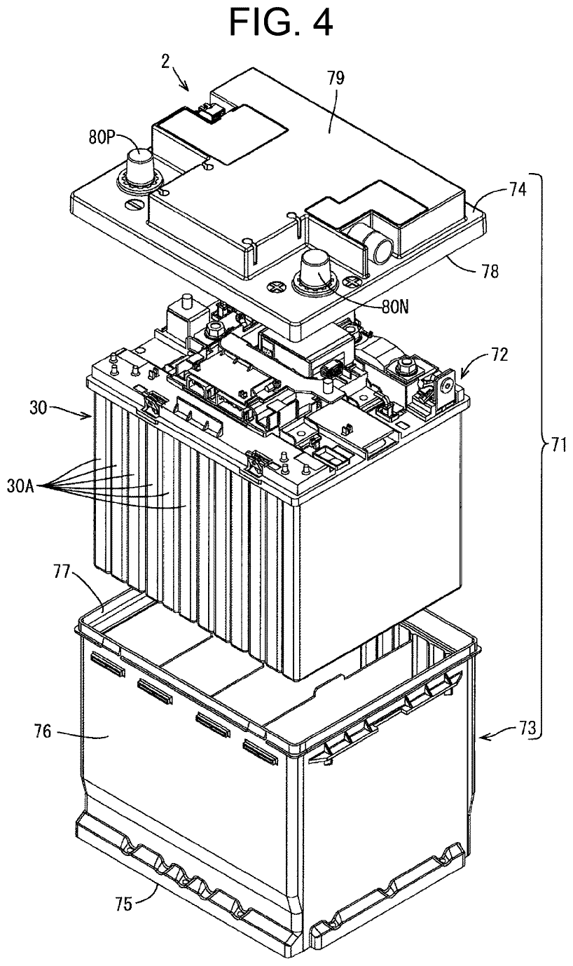

As illustrated in FIG. 4, the energy storage apparatus 2 includes a housing body 71. The housing body 71 includes a main body 73 and a lid body 74 which are made of a synthetic resin material. The main body 73 has a bottom-closed cylindrical shape. The main body 73 is provided with a bottom surface portion 75 and four side surface portions 76. An upper opening portion 77 is formed at an upper end part by the four side surface portions 76.

The housing body 71 houses therein a battery pack 30 constituted of a plurality of energy storage cell 30A and a circuit board unit 72. The energy storage cell 30A is a repeatedly chargeable and dischargeable secondary battery, and to be more specific, is a lithium-ion secondary battery, for example. The circuit board unit 72 is disposed on an upper part of the battery pack 30.

The lid body 74 closes the upper opening portion 77 of the main body 73. An outer peripheral wall 78 is provided around the lid body 74. The lid body 74 includes a protruding portion 79 which is roughly T-shaped in a plan view. A positive electrode external terminal 80P is fixed to one corner portion of a front portion of the lid body 74, and a negative electrode external terminal 80N is fixed to an other corner portion.

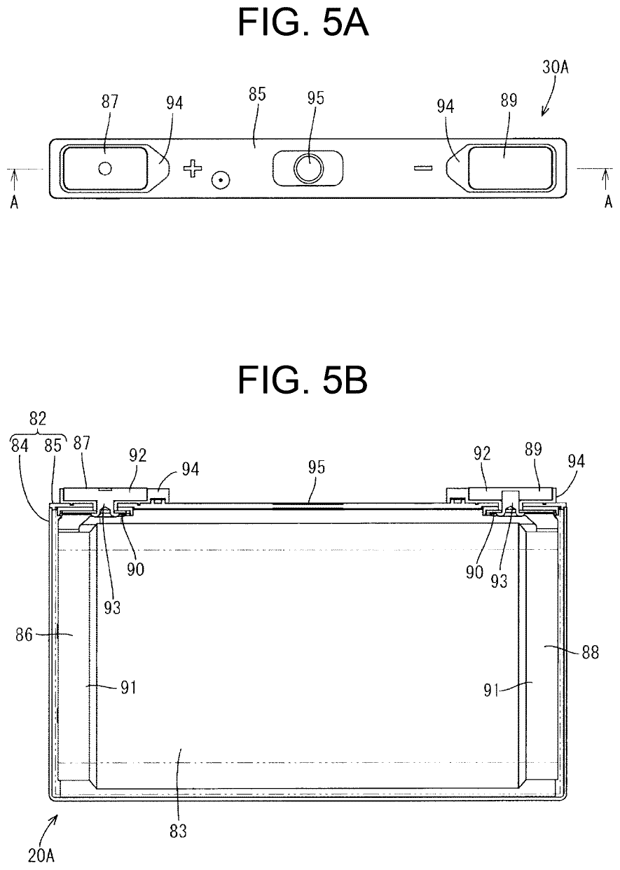

As illustrated in FIGS. 5A and 5B, the energy storage cell 30A is obtained by accommodating an electrode body 83, together with a non-aqueous electrolyte, in a case 82 having a rectangular parallelepiped shape. The case 82 includes a case main-body 84 and a lid 85 which closes an opening portion above the case main-body 84.

Although not illustrated in detail, the electrode body 83 is obtained by arranging a separator made of a porous resin film between a negative electrode element having a negative electrode active material applied to a base material that is made of copper foil and a positive electrode element having a positive electrode active material applied to a base material that is made of aluminum foil. The above components are all band-shaped, and are wound in a flat shape such that they can be accommodated in the case main-body 84 in such a state that the negative electrode element and the positive electrode element are positionally shifted to the respectively opposite sides in a width direction with respect to the separator.

A positive electrode terminal 87 is connected to the positive electrode element via a positive electrode current collector 86, and a negative electrode terminal 89 is connected to the negative electrode element via a negative electrode current collector 88. The positive electrode current collector 86 and the negative electrode current collector 88 are each composed of a pedestal portion 90 having a flat plate shape, and a leg portion 91 extending from the pedestal portion 90. A through hole is formed in the pedestal portion 90. The leg portion 91 is connected to the positive electrode element or the negative electrode element. Each of the positive electrode terminal 87 and the negative electrode terminal 89 includes a terminal main-body portion 92 and a shaft portion 93 protruding downward from a central portion of a lower surface of the terminal main-body portion 92. Of the above, the terminal main-body portion 92 and the shaft portion 93 of the positive electrode terminal 87 are integrally formed of aluminum (a single material). In the negative electrode terminal 89, the terminal main-body portion 92 is made of aluminum and the shaft portion 93 is made of copper, and they are assembled together in the negative electrode terminal 89. The terminal main-body portions 92 of the positive electrode terminal 87 and the negative electrode terminal 89 are disposed at both end portions of the lid 85 via gaskets 94 made of an insulating material, and are exposed to outside from the gaskets 94.

As illustrated in FIG. 5A, the lid 85 includes a pressure release valve 95. The pressure release valve 95 is positioned between the positive electrode terminal 87 and the negative electrode terminal 89. When the internal pressure of the case 82 exceeds a limit value, the pressure release valve 95 is opened to lower the internal pressure of the case 82.

### (3) Electrical Configuration of Energy Storage Apparatus

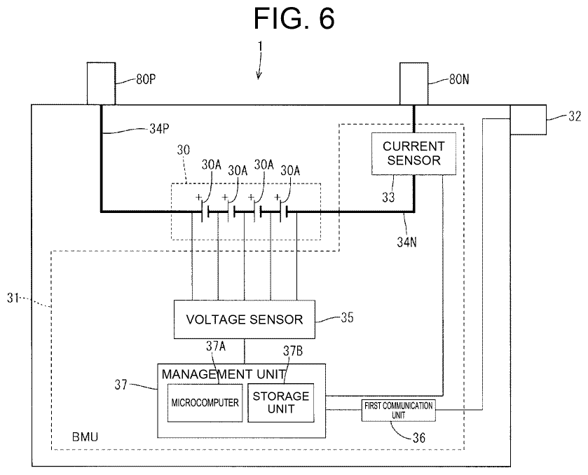

As illustrated in FIG. 6, the energy storage apparatus 2 is provided with the battery pack 30, a battery management unit (BMU 31), and a communication connector 32. The BMU 31 is an example of a management device.

The battery pack 30 is connected to the positive electrode external terminal 80P by a power line 34P, and is connected to the negative electrode external terminal 80N by a power line 34N. In the battery pack 30, twelve energy storage cell 30A are connected to establish a three parallel and four series connection. In FIG. 4, three energy storage cell 30A connected in parallel are represented by one battery symbol.

The BMU 31 is an apparatus which manages the energy storage apparatus 2. The BMU 31 includes a current sensor 33, a voltage sensor 35, a first communication unit 36, and a management unit 37. The BMU 31 is operated by electric power supplied from the battery pack 30.

The current sensor 33 is included in the power line 34N. The current sensor 33 measures a charge/discharge current [I] of the energy storage cell 30A, and outputs the charge/discharge current [I] to the management unit 37.

The voltage sensor 35 is connected to each of both ends of each energy storage cell 30A. The voltage sensor 35 measures the voltage [V] of each of the energy storage cell 30A and outputs the measured voltage to the management unit 37.

The first communication unit 36 is a circuit for the management unit 37 to communicate with the on-board ECU 10.

The management unit 37 is provided with: a microcomputer 37A including a CPU and a RAM, etc., as one chip; and a storage unit 37B. The microcomputer 37A manages each unit of the energy storage apparatus 2 by executing a control program (so-called firmware) stored in the storage unit 37B. The storage unit 37B includes a non-volatile storage medium which can be repeatedly rewritten. The storage unit 37B stores therein the control program to be executed by the management unit 37 and various kinds of data. The various kinds of data include a predetermined pattern.

The communication connector 32 is a connector to which the signal line 18 for use by the management unit 37 to communicate with the on-board ECU 10 is connected.

### (4) Communication Between On-Board ECU and Energy Storage Apparatus

The management unit 37 of the energy storage apparatus 2 communicates with the on-board ECU 10 via the first communication unit 36. Here, as the communication between the management unit 37 and the on-board ECU 10, communication for the on-board ECU 10 to transmit update firmware to the management unit 37 of the energy storage apparatus 2 is exemplified below. The communication between the management unit 37 and the on-board ECU 10 is not limited thereto, and is performed for any appropriate purposes.

The on-board ECU 10 receives the update firmware of the management unit 37 from a manufacturer, or the like, of the energy storage apparatus 2 via the third communication unit 22. The on-board ECU 10 transmits the received update firmware to the management unit 37 via the second communication unit 21. When the management unit 37 receives the update firmware, the management unit 37 updates the firmware stored in the storage unit 37B with the received update firmware.

Here, in the case of receiving the update firmware from the on-board ECU 10, the management unit 37 detects, before receiving the update firmware, a pulse pattern occurring in the charge/discharge current of the energy storage cell 30A, and determines, from the detected pulse pattern, whether or not the communication counterpart is the legitimate communication counterpart (i.e., the vehicles 3) with which the management unit 37 determined a predetermined pattern in advance. The management unit 37 receives the update firmware when it is determined that the communication counterpart is the vehicle 3.

The pulse pattern is described below with reference to FIG. 2. Before transmitting the update firmware, the on-board ECU 10 turns on/off the first FET 14 or the second FET 15 according to a predetermined pattern, thereby generating a pulse pattern 25 in the charge/discharge current of the energy storage cell 30A.

The predetermined pattern is information indicating the pulse pattern 25, and is specifically information indicating the number of pulses, a pulse width, a pulse interval, and the like. The predetermined pattern can also be rephrased as an encryption pattern. The pulse widths and the pulse intervals of the plurality of pulses constituting the pulse pattern 25 may not be constant.

For example, a plurality of types of pulse widths may be mixed, or a plurality of types of pulse intervals may be mixed.

The predetermined pattern is preferably a pattern that cannot be easily created (or imitated). For example, when a pulse pattern 25 in which a plurality of types of pulse widths and a plurality of types of pulse intervals are complicatedly combined is generated, it is difficult for a third party to guess the pulse pattern 25, and therefore, the robustness against cyberattacks is further improved.

An operation in which the on-board ECU 10 generates the pulse pattern 25 is more specifically described below. When a discharge current is flowing from the energy storage cell 30A to the auxiliary machines 11, the on-board ECU 10 generates a pulse pattern 25 in the discharge current by turning on/off the first FET 14. Similarly, when a discharge current is flowing from the energy storage cell 30A to the engine starting device of the high-voltage system 12, the on-board ECU 10 generates a pulse pattern 25 in the discharge current by turning on/off the second FET 15. When a charge current is flowing from the vehicular power generator of the high-voltage system 12 to the energy storage cell 30A, the on-board ECU 10 generates the pulse pattern 25 in the charge current by turning on/off the second FET 15.

### (5) Communication Processing with On-Board ECU

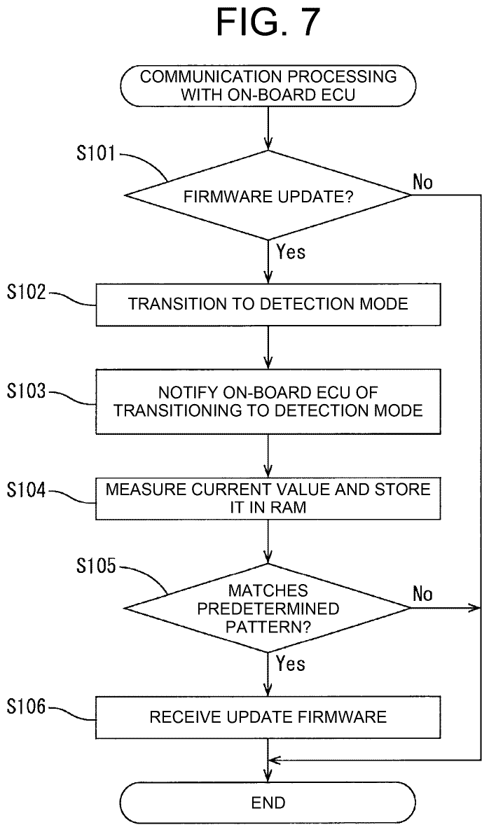

A flow of communication processing with an on-board ECU 10, which is executed by the management unit 37, is described below with reference to FIG. 7. Here, communication for the on-board ECU 10 to transmit update firmware to the management unit 37 of the energy storage apparatus 2 is described below as an example. This processing is started when the on-board ECU 10 requests the management unit 37 to start communication.

In S101, the management unit 37 determines whether or not the requested communication is communication for transmitting the update firmware. If the communication is for transmitting the update firmware, the management unit 37 proceeds to S102, and if the communication is not for transmitting the update firmware, the present processing is ended. Although not illustrated in FIG. 7, if the communication is not for transmitting the update firmware, the requested communication is separately performed after this processing is ended.

In S102, the management unit 37 transitions to a detection mode in which the pulse pattern 25 occurring in the charge/discharge current of the energy storage cell 30A is detected.

In the S103, the management unit 37 notifies the on-board ECU 10 that the transition to the detection mode has occurred, via the first communication unit 36.

When the on-board ECU 10 is notified that the transition to the detection mode has occurred, the on-board ECU 10 turns on/off the first FET 14 or the second FET 15 according to the predetermined pattern, thereby generating a pulse pattern 25 according to the predetermined pattern in the charge/discharge current of the energy storage cell 30A.

In S104, the management unit 37 repeatedly measures a current value by the current sensor 33 for a predetermined time (a time equal to or longer than a time necessary to generate the pulse pattern 25 in the charge/discharge current), and stores the measured current value in the RAM.

The current value to be stored in the RAM may be only the current value for the latest predetermined time. That is, the current value measured before the latest predetermined time may be erased from the RAM.

In S105, the management unit 37 detects a pulse pattern occurring in the charge/discharge current from the plurality of current values stored in the RAM, and determines whether or not the detected pulse pattern matches a predetermined pattern (an example of determination processing). If they match, the management unit 37 determines that the communication counterpart is the legitimate communication counterpart, and proceeds to S106. If they do not match, the management unit 37 determines that the communication counterpart is not the legitimate communication counterpart, and ends the processing. In other words, the management unit 37 refuses to receive the update firmware.

In the S106, the management unit 37 receives the update firmware from the on-board ECU 10 via the first communication unit 36 (an example of communication processing). This communication is performed in an encrypted manner.

### (6) Effects of the Embodiments

According to the BMU 31 of the first embodiment, it is determined whether or not the pulse pattern 25 occurring in the charge/discharge current of the energy storage cell 30A matches a predetermined pattern. By doing so, the BMU 31 can determine whether or not the communication counterpart is the legitimate communication counterpart with which the BMU 31 determined a predetermined pattern in advance. Since cyberattacks mainly infiltrate through the first communication unit 36, robustness against cyberattacks on the BMU 31 improves by determining, from the pulse pattern 25, whether or not the communication counterpart is the legitimate communication counterpart, and rejecting communication via the first communication unit 36 when the communication counterpart is not the legitimate communication counterpart.

That is, by generating and utilizing a predetermined pattern that cannot be easily reproduced or generated, a more robust system can be constructed.

According to the BMU 31, by using both the pulse pattern 25 to be generated in the charge/discharge current of the energy storage cell 30A and encryption of communication, the robustness of security is further improved.

According to the BMU 31, determination processing (S105) is executed before the update firmware is received, and the update firmware is received when it is determined in the affirmative in the determination processing. In other words, the BMU 31 receives the update firmware after confirming that the transmission source of the update firmware is the legitimate communication counterpart. By doing so, it is possible to reduce the possibility that the firmware of the management unit 37 included in the BMU 31 will be updated by falsified firmware.

According to the energy storage apparatus 2 of the first embodiment, by determining whether or not the communication counterpart is the legitimate communication counterpart, from the pulse pattern 25 occurring in the charge/discharge current of the energy storage cell 30A, robustness against cyberattacks on the BMU 31 improves.

According to the system 1 of the first embodiment, by determining whether or not the communication counterpart is the legitimate communication counterpart, from the pulse pattern 25 occurring in the charge/discharge current of the energy storage cell 30A, robustness against cyberattacks on the BMU 31 improves.

### Second Embodiment

In the above-described first embodiment, as an example of a case in which communication is requested from the on-board ECU 10 to the management unit 37 of the energy storage apparatus 2, communication for the on-board ECU 10 to transmit update firmware to the management unit 37 of the energy storage apparatus 2 has been exemplified. On the other hand, in a second embodiment, as an example of a case in which communication is requested from an on-board ECU 10 to a management unit 37 of an energy storage apparatus 2, communication for an outside diagnostic apparatus (hereinafter referred to as an external diagnostic apparatus) to be connected to a vehicle 3 to diagnose the presence or absence of an abnormality in the BMU 31 via the on-board ECU 10 is exemplified below. The external diagnostic apparatus is an example of an apparatus that exchanges signals with the management device.

The vehicle 3 is provided with a connector for connecting an external diagnostic apparatus. The external diagnostic apparatus is connected to the connector via the communication cable when diagnosing the presence or absence of a failure in the BMU 31. The connector is connected to the on-board ECU 10.

The external diagnostic apparatus communicates with the management unit 37 via the on-board ECU 10. That is, the on-board ECU 10 relays communication between the external diagnostic apparatus and the management unit 37.

A flow of communication between an on-board ECU 10 and a management unit 37 according to the second embodiment is substantially the same as the corresponding flow of the first embodiment, except that the communication is for an external diagnostic apparatus to diagnose the presence or absence of an abnormality in the BMU 31, and therefore, description thereof is omitted below.

According to the BMU 31 of the second embodiment, the determination processing (S105) is executed before the diagnosis by the external diagnostic apparatus is accepted via the first communication unit 36, and the diagnosis by the external diagnostic apparatus is accepted (S106) when it is determined in the affirmative in the determination processing. By doing so, it is possible to reduce the possibility that the information of the management unit 37 included in the BMU 31 is fraudulently acquired.

### Third Embodiment

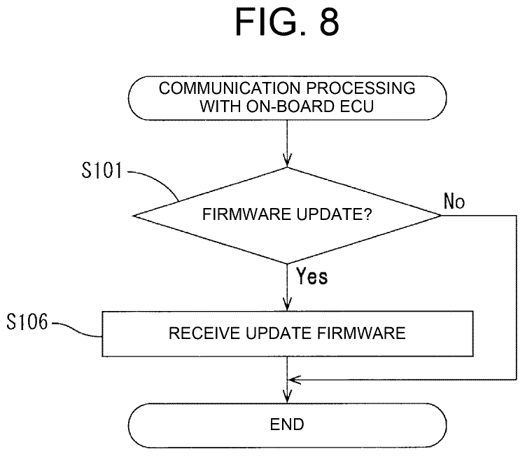

A third embodiment is described below with reference to FIG. 8.

In the above-described first and second embodiments, the management unit 37 detects the pulse pattern 25 every time communication (communication for the on-board ECU 10 to transmit update firmware or communication for the external diagnostic apparatus to diagnose the presence or absence of an abnormality in the BMU 31) is performed, and determines whether or not the communication counterpart is the legitimate communication counterpart. In contrast, the management unit 37 according to the third embodiment determines whether or not the pulse pattern 25 matches the predetermined pattern only when such communication is performed for the first time after the energy storage apparatus 2 is mounted in the vehicle 3, and if they match, the management unit 37 communicates with the on-board ECU 10 without determining whether or not the pulse pattern 25 matches the predetermined pattern upon second and subsequent communications.

A flow to be followed to communication with the on-board ECU 10 for the first time is substantially the same as the flow in the first embodiment and the second embodiment, and therefore, description thereof is omitted.

A flow of second and subsequent communications is described below with reference to FIG. 8. Here, communication for the on-board ECU 10 to transmit the update firmware to the management unit 37 of the energy storage apparatus 2 is exemplified below. As illustrated in FIG. 8, S102 to S105 are not executed upon second and subsequent communications. Therefore, the BMU 31 receives the update firmware from the on-board ECU 10 without detecting the pulse pattern 25 (S106).

According to the BMU 31 of the third embodiment, the determination processing (S105) is executed upon first communication with the vehicles 3, and when it is determined in the affirmative in the determination processing, the determination processing is not executed upon second and subsequent communications, and therefore the time required for the second and subsequent communications can be shortened.

### Fourth Embodiment

In the fourth embodiment, the BMU 31 generates a predetermined pattern at a certain timing.

The certain timing may be, for example, regular timing, may be when a predetermined pattern generation signal is received from the on-board ECU 10, may be when a request to generate a predetermined pattern is made by a user, or may be when a certain threat (data interference, infiltration, data tampering, or the like) is detected. Here, a case where the predetermined pattern generation signal is received from the on-board ECU 10 is described below as an example.

The on-board ECU 10 transmits a predetermined pattern generation signal to the BMU 31 when communicating with the BMU 31 (for example, when transmitting the update firmware to the BMU 31).

Upon receiving the predetermined pattern generation signal, the BMU 31 generates a predetermined pattern, and replaces the existing predetermined pattern with the generated predetermined pattern (i.e., changes the predetermined pattern). Then, the BMU 31 transmits the replaced predetermined pattern to the on-board ECU 10.

Upon receiving the predetermined pattern from the BMU 31, the on-board ECU 10 generates a pulse pattern in the charge/discharge current on the basis of the received predetermined pattern.

According to the BMU 31 of the fourth embodiment, by generating a predetermined pattern, the predetermined pattern can be replaced (i.e., the predetermined pattern can be changed).

Accordingly, robustness against cyberattacks on the BMU 31 is further improved as compared to a case where the predetermined pattern is fixed to a single predetermined pattern.

### Other Embodiment(s)

The present invention is not limited to the embodiments explained with reference to the above description and the drawings, and the technical scope of the present invention also incorporates therein, for example, the following embodiments.

(1) In the above-described embodiments, a case in which the pulse pattern 25 (i.e., the predetermined pattern) to be generated in the charge/discharge current and encryption of communication are used in combination has been exemplified; however, the communication does not have to be encrypted.

(2) In the above-described embodiments, the vehicle 3 has been exemplified as an apparatus to which electric power is supplied from the energy storage cell 30A or an apparatus that charges the energy storage cell 30A; however, the apparatus is not limited to the vehicles 3, and may be other devices.

(3) In the above-described embodiments, there is only one predetermined pattern; however, there may be a plurality of predetermined patterns. The plurality of predetermined patterns may be used in order, may be selectively used according to the communication content, or may be selected according to a certain rule. The predetermined pattern generated by way of the rolling code (an electronic code including a plurality of elements whose combination is irregularly changed each time the transmission unit is operated) may be further changed.

(4) In the above-described embodiments, the vehicle 3 includes the first FET 14 and the second FET 15; however, the vehicle 3 may include a relay instead of the FETs.

(5) In the above-described embodiments, the vehicle 3 has been exemplified as the apparatus.

The vehicle 3 is an apparatus to which electric power is supplied from the energy storage cell 30A, and is an apparatus that charges the energy storage cell 30A. On the other hand, the apparatus may be an apparatus to which an electric power is supplied from the energy storage cell 30A but that does not charge the energy storage apparatus 2, or may be an apparatus that charges the energy storage cell 30A but to which no electric power is supplied from the energy storage apparatus 2.

In the above-described embodiments, a case in which the on-board ECU 10 requests the management unit 37 to perform communication has been exemplified; however, the management unit 37 may request the on-board ECU 10 to perform communication. For example, the management unit 37 may request the on-board ECU 10 to perform communication for notifying the on-board ECU 10 of the state of the energy storage apparatus 2. In this case, the management unit 37 requests the on-board ECU 10 to perform communication, and then proceeds to the detection mode. The on-board ECU 10 requested to communicate generates a pulse pattern in the charge/discharge current of the energy storage cell 30A. The management unit 37 detects the pulse pattern, and when the detected pulse pattern matches a predetermined pattern, the management unit 37 notifies the on-board ECU 10 of the state of the energy storage apparatus 2.

(7) In the above-described embodiments, although a lithium-ion secondary battery has been described as an example of the energy storage cell 30A, the energy storage cell 30A may be a capacitor involving an electrochemical reaction.

(8) In the above-described embodiments, a case in which whether or not the communication counterpart is the legitimate communication counterpart is determined from the pulse pattern occurring in the charge/discharge current of the energy storage cell 30A has been exemplified. However, the method of determining whether or not the communication counterpart is the legitimate communication counterpart is not limited thereto.

For example, the BMU 31 may be provided with a temperature sensor that measures the temperature of the energy storage cell 30A, and the on-board ECU 10 may cause a signal pattern (a signal of 0 or 1 or any duty signal) corresponding to the predetermined pattern to occur in a signal output from the temperature sensor. The temperature sensor is not limited to a sensor that measures the temperature of the energy storage cell 30A, and may be a sensor that detects the temperature of the housing body 71 of the energy storage apparatus 2. The temperature sensor may be disposed inside the housing body 71, or may be disposed outside the housing body 71.

The on-board ECU 10 may generate a signal pattern in the signal output from the voltage sensor 35 of the energy storage cell 30A.

All or a part of communication signals (request signals or answer signals) exchanged between the on-board ECU 10 and the BMU 31, or determination values such as mirror values and checksum values may be utilized as the predetermined pattern (may be either utilized as the predetermined pattern itself, or added to the existing predetermined pattern).

(9) In the above-described fourth embodiment, the BMU 31 replaces the existing predetermined pattern with a generated predetermined pattern; however, all or a part of the generated predetermined pattern may be added to the existing predetermined pattern, instead.

The predetermined pattern to be generated may be an analog signal instead of a digital signal.

Then, the BMU 31 may convert the analog signal into a digital signal, and set the digital signal as the predetermined pattern. Regardless of whether the signal is a digital signal or an analog signal, a signal on which noise is accidentally superimposed may be generated as the predetermined pattern.

(10) In the above-described embodiments, a case in which the BMU 31 detects both the pulse pattern occurring in the charge current and the pulse pattern occurring in the discharge current has been exemplified. On the other hand, the BMU 31 may detect only the pulse pattern occurring in the charge current, or may detect only the pulse pattern occurring in the discharge current. That is, detecting the pulse pattern occurring in the charge/discharge current of the energy storage cell 30A includes not only a case of detecting both the pulse pattern occurring in the charge current and the pulse pattern occurring in the discharge current, but also a case of detecting only the pulse pattern occurring in the charge current, and a case of detecting only the pulse pattern occurring in the discharge current.

1. A management device that manages an energy storage cell, the management device comprising:
a current sensor that measures a charge/discharge current in the energy storage cell;
a first communication unit that communicates with at least one apparatus from among an apparatus to which electric power is supplied from the energy storage cell, an apparatus that charges the energy storage cell, and an apparatus that exchanges signals with the management device; and
a management unit, wherein
the management unit executes:
determination processing of detecting, by the current sensor, a pulse pattern occurring in the charge/discharge current in the energy storage cell, and determining whether or not the detected pulse pattern matches a predetermined pattern; and
communication processing of communicating with the apparatus via the first communication unit when it is determined in the affirmative in the determination processing.

2. The management device according to claim 1, wherein
the management unit performs encrypted communication with the apparatus via the first communication unit.

3. The management device according to claim 1, wherein
in the case of receiving update firmware of the management unit from the apparatus via the first communication unit, the management unit executes the determination processing before receiving the update firmware, and when it is determined in the affirmative in the determination processing, the management unit receives the update firmware from the apparatus via the first communication unit in the communication processing.

4. The management device according to claim 1, wherein
in the case of accepting, via the first communication unit, diagnosis by an external diagnostic apparatus that diagnoses presence or absence of an abnormality in the management device, the management unit executes the determination processing before accepting the diagnosis by the external diagnostic apparatus, and when it is determined in the affirmative in the determination processing, the management unit accepts the diagnosis by the external diagnostic apparatus via the first communication unit in the communication processing.

5. The management device according to claim 1, wherein
the management unit executes the determination processing upon first communication with the apparatus, and when it is determined in the affirmative in the determination processing, the management unit communicates with the apparatus via the first communication unit without executing the determination processing upon second and subsequent communications with the apparatus.

6. An energy storage apparatus comprising:
an energy storage cell; and
the management device according to claim 1 managing the energy storage cell.

7. A system comprising:
the energy storage apparatus according to claim 6; and
at least one apparatus, being from among an apparatus to which electric power is supplied from the energy storage apparatus, an apparatus that charges the energy storage apparatus, and an apparatus that exchanges signals with the management device; and including a second communication unit that communicates with the management device, wherein the apparatus includes a pulse generator that generates a pulse pattern in accordance with the predetermined pattern, in the charge/discharge current in the energy storage apparatus.

8. A communication method for use in a management device that manages an energy storage cell, the communication method comprising:
determination of detecting, by a current sensor, a pulse pattern occurring in a charge/discharge current in the energy storage cell, and determining whether or not the detected pulse pattern matches a predetermined pattern; and
communication of communicating with an apparatus via a first communication unit when it is determined in the affirmative in the determination.

9. A communication method for use in communication between an apparatus and a management device that manages an energy storage cell, the communication method comprising:
generation in which the apparatus generates a pulse pattern in accordance with a predetermined pattern, in a charge/discharge current in the energy storage cell;
determination in which the management device detects, by a current sensor, the pulse pattern occurring in the charge/discharge current in the energy storage cell, and determines whether or not the detected pulse pattern matches the predetermined pattern; and
communication in which the apparatus and the management device communicate with each other when it is determined in the affirmative in the determination.

10. A communication method for use in a management device that manages an energy storage cell, the communication method comprising:
determination of detecting, by a current sensor, a pulse pattern occurring in a charge/discharge current in the energy storage cell, and determining whether or not the detected pulse pattern matches a predetermined pattern;
communication of communicating with an apparatus via a first communication unit when it is determined in the affirmative in the determination; and
generation of generating the predetermined pattern.
